(19) United States
(12) Patent Application Publication
(10) Pub. No.: US 2008/0285132 A1
(43) Pub. Date: Nov. 20, 2008

(54) Element deflector for lenses, and/or method of making the same

(76) Inventor: Kevin James O'Kane, Studio City, CA (US)

Correspondence Address: NIXON & VANDERHYE, PC, 901 NORTH GLEBE ROAD, 11TH FLOOR, ARLINGTON, VA, 22203, US

(21) Appl. No.: 12/078,557

(22) Filed: Apr. 1, 2008

Related U.S. Application Data
(63) Continuation-in-part of application No. 11/802,085, filed on May 18, 2007.

(51) Int. Cl. G02B 7/02

(52) U.S. Cl. 359/509

(57) ABSTRACT

Certain example embodiments of this invention relate to element deflectors and/or methods of making the same that are capable of reducing the number and/or amount of deposits (e.g., moisture and/or debris) that form on the lens(es) of viewing devices that reduce the viewing quality and/or experience. An air supply is configured to supply a flow of pressurized air. A matte box includes a plurality of holes and/or jets formed in or around a frame or hood thereof, with the plurality of holes or jets being disposed at one or more angles such that the flow of pressurized air is capable of flowing therethrough to reduce the number and/or amount of deposits from forming on the lens of the viewing device. A conduit connects the air supply to the holes or jets so that the flow of pressurized air flows from the air supply through the conduit to the holes or jets. The holes or jets may be capable or creating a desirable cyclonic or swirling effect for the air. Such techniques optionally may be used with or without a matte box, and/or with or without a spray deflector.

### CROSS-REFERENCE TO RELATED APPLICATION

This application is a continuation-in-part (CIP) of application Ser. No. 11/802,085, filed on May 18, 2007, the entire contents of which are hereby incorporated herein by reference.

### FIELD OF THE INVENTION

Certain example embodiments of this invention relate to techniques for improving the quality of viewing experiences using a viewing device such as, for example, video cameras, still cameras, telescopes, binoculars, scopes, glasses or goggles, etc. More particularly, certain example embodiments of this invention relate to element deflectors for lenses, forced air environmental separators, and/or methods of making the same that are capable of reducing the number and/or amount of deposits (e.g., moisture and/or debris) that form on the lens(es) of viewing devices that reduce the viewing quality and/or experience.

### BACKGROUND AND SUMMARY OF EXAMPLE EMBODIMENTS OF THE INVENTION

Hundreds of thousands of dollars are spent each year to purchase the latest and best viewing devices, with such viewing devices including, for example, video cameras, still cameras, telescopes, binoculars, scopes, glasses or goggles, etc. Indeed, individuals, corporations, and governments purchase new viewing devices every year to replace older models, for example, with newer models that include improved viewing features. Such improved viewing features may include better qualities lenses, higher resolution image and/or video capture, more highly powered zooms, etc. Other individuals, corporations, and governments are first-time purchasers of viewing devices.

In many cases, individuals, corporations, and governments use such viewing devices for a variety of purposes, including photography, video, stargazing, hunting, etc. The viewing device typically may become a medium through which individuals observe and/or capture special times. Alternatively or in addition, the viewing device may be an integral part of a broadcasting corporation. In still other example instances, governments may require such devices when responding to emergency situations (e.g., in the case of first responders, emergency care providers, relief workers, etc.). Regardless of the reason for the use, the occasion, and/or the particular viewing device, in general, individuals, corporations, and governments invest time and money in the same, hoping to obtain a quality end-product that meets or exceeds their expectations.

Unfortunately, despite the above-noted and/or other improvements, viewing devices in general suffer from several disadvantages. For example, moisture caused by, for example, rain, snow, sleet, ice, etc., as well as debris including dust, dirt, pollen, and other materials may come into contact with the lens of the viewing device. This may obstruct the view and/or result in a degraded image or image quality and/or video being captured and/or broadcast. Indeed, the viewing opportunity may be completely lost in some cases.

FIG. 1 is a typical outdoor situation in which moisture may form on a camera lens, causing a broadcast image to be degraded. In FIG. 1, a video camera 102 including a lens 104 is located outside. The video camera 102 may be stationary, a standard pan-tilt-zoom camera, or it may be mobile. In the example of FIG. 1, the video camera 102 is trained on the field of view 106, and rain 108 is falling from above. If, for example, the winds change, the camera is moved in a particular direction, or the rain 108 for some reason falls in a direction other than straight up-and-down (which is likely the case, particularly in draft-prone areas), moisture may collect on the lens. The resulting captured image and resulting broadcast is shown in FIG. 2.

More particularly, FIG. 2 is an example television 202 displaying a live broadcast from the video camera 102 in FIG. 1. The television 202 shows on its screen 204 an image of the field of view 106. Water droplets 206 are at least partially obstructing the view. In this example, the view is only partially obstructed by several well-defined water droplets 106. However, it will be appreciated that the situation may be much worse if, for example, the rain falls more heavily, the wind blows more strongly, etc. Indeed, the field may be completely unperceivable in certain circumstances. This reduction in viewing quality may result in frustration, missed viewing and/or recording opportunities, lost revenues, lost memories, and/or general disappointment.

As suggested above, such situations arise not only in inclement weather, but also in other situations where deposits may form on the lens. For example, a vehicle kicking up dust, dirt, gravel, etc. may also cause obstructing deposits. Skiing, motor cross, and other activities often present similar challenges. Various indoor events also may cause the same or similar situations.

Thus, it will be appreciated that there is a need in the art for techniques that overcome one or more of the above noted disadvantages and/or provide better viewing opportunities with respect to viewing devices.

One aspect of certain example embodiments of this invention relates to techniques for reducing the number and/or amount of deposits forming on a lens of a viewing device.

Another aspect of certain example embodiments relates to techniques for forcing air through a plurality of holes disposed around a collar of a forced air environmental separator apparatus.

Yet another aspect of certain example embodiments relates to the plurality of holes in the collar of the forced air environmental separator being disposed at one or more angles so as to focus the air into one or more focal points to form, for example, a cone and/or pyramid of air.

Still another aspect of certain example embodiments relates to a forced air environmental separator that is connectable to a viewing device and/or built into viewing device itself.

One aspect of certain example embodiments of this invention relates to techniques for forcing air through a plurality of holes and/or jets disposed around a frame or hood of a matte box of a viewing device.

Another aspect of certain example embodiments relates to generating a swirling or cyclonic effect of air from holes and/or jets disposed around the lens of a viewing device.

Certain example embodiments may be used in connection with, for example, a video camera, still camera, telescope, binoculars, glasses or goggles, and/or a scope.

Certain example embodiments may be used for, for example, sporting events, amateur or professional still photography, wildlife photography, hunting, surveillance, traffic cameras (e.g., red light cameras, speeding cameras, etc.), astronomy, weather watching, special effects, stunt photography, concerts, movie and/or television products, skiing, motor cross, emergency response, etc.

According to certain example embodiments, a forced air environmental separator for use with a viewing device configured to reduce a number and/or amount of deposits from forming on a lens of the viewing device is provided. An air supply may be configured to supply a flow of pressurized air. A collar may include a plurality of holes formed therein. The plurality of holes may be disposed at one or more angles such that the flow of pressurized air is capable of flowing therethrough. A conduit may connect the air supply to the collar such that the flow of pressurized air flows from the air supply through the conduit to the collar.

According to certain other example embodiments, a viewing device comprising a lens and a forced air environmental separator configured to reduce a number and/or amount of deposits from forming on the lens of the viewing device is provided. The forced air environmental separator of the viewing device may comprise an air supply configured to supply a flow of pressurized air. A collar may include a plurality of holes formed therein, with the collar being at least as big as the lens, and with the plurality of holes being disposed at one or more angles such that the flow of pressurized air is capable of flowing therethrough. A conduit may connect the air supply to the collar such that the flow of pressurized air flows from the air supply through the conduit to the collar.

According to certain other example embodiments, a method of reducing the number of deposits that form on a lens of a viewing device is provided. A supply of pressurized gas may be provided from an air source. The supply of pressurized gas may be forced from the air source through a tube into a collar having a plurality of holes disposed therein. The supply of pressurized gas may be focused into at least one focal point at one or more predetermined locations relative to the lens and/or collar.

In certain example embodiments of this invention, a viewing device comprising an element deflector configured to reduce a number and/or amount of deposits from forming on a lens of the viewing device is provided. An air supply is configured to supply a flow of pressurized air. A matte box includes a plurality of holes formed in a frame or hood thereof, with the plurality of holes being disposed at one or more angles such that the flow of pressurized air is capable of flowing through the holes to reduce the number and/or amount of deposits from forming on the lens of the viewing device. A conduit connects the air supply to the holes of the matte box so that the flow of pressurized air flows from the air supply through the conduit to the holes of the matte box.

In certain example embodiments, a viewing device comprising an element deflector configured to reduce a number and/or amount of deposits from forming on a lens of the viewing device is provided. An air supply is configured to supply a flow of pressurized air. A plurality of rotatable and/or translatable jets is formed around the lens of the viewing device, with the plurality of jets being positionable at one or more angles such that the flow of pressurized air is capable of flowing therethrough to reduce the number and/or amount of deposits from forming on the lens of the viewing device. A conduit connects the air supply to the jets so that the flow of pressurized air flows from the air supply through the conduit to the jets.

In certain example embodiments, a method of reducing the number of deposits that form on a lens of a viewing device is provided. A supply of pressurized gas from an air source is provided. The supply of pressurized gas from the air source is forced through a tube through a plurality of holes or jets disposed in a frame or hood of a matte box of the viewing device. The supply of pressurized gas is focused into at least one focal point at one or more predetermined locations relative to the lens.

These aspects and example embodiments may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 is a typical outdoor situation in which moisture may form on a camera lens, causing a broadcast image to be degraded;

FIG. 2 is an example television displaying a live broadcast from the video camera in FIG. 1;

FIG. 3a is an example forced air environmental separator device, in accordance with an example embodiment;

FIG. 3b is another example forced air environmental separator device, in accordance with an example embodiment;

FIG. 3c is still another example forced air environmental separator device, in accordance with an example embodiment;

FIG. 3d is an example forced air environmental separator device having an illustrative dial for adjusting air flow, in accordance with an example embodiment;

FIG. 3e is another example forced air environmental separator device having an illustrative dial for adjusting air flow, in accordance with an example embodiment;

FIG. 3f is still another example forced air environmental separator device having an illustrative dial for adjusting air flow, in accordance with an example embodiment;

FIG. 4a is a simplified cross-sectional view of the example forced air environmental separator device of FIG. 3a, in accordance with an example embodiment;

FIG. 4b is a partial perspective view of the example forced air environmental separator device of FIG. 3a, in accordance with an example embodiment;

FIG. 5a is a video camera including a forced air environmental separator device of FIG. 3a, in accordance with an example embodiment;

FIG. 5b is another video camera including a forced air environmental separator device located in the frame or hood of its matte box, in accordance with an example embodiment;

FIG. 5c is still another video camera including a forced air environmental separator device, in accordance with an example embodiment;

FIG. 6 is an illustrative flowchart showing a method for reducing the number of deposits that may form on a lens of a viewing device;

FIG. 7a is an illustrative air jet that may be moved in six degrees of freedom, in accordance with an example embodiment; and

FIG. 7b is an illustrative forced air environmental separator device including a plurality of the illustrative air jets shown in FIG. 7a, in accordance with an example embodiment.

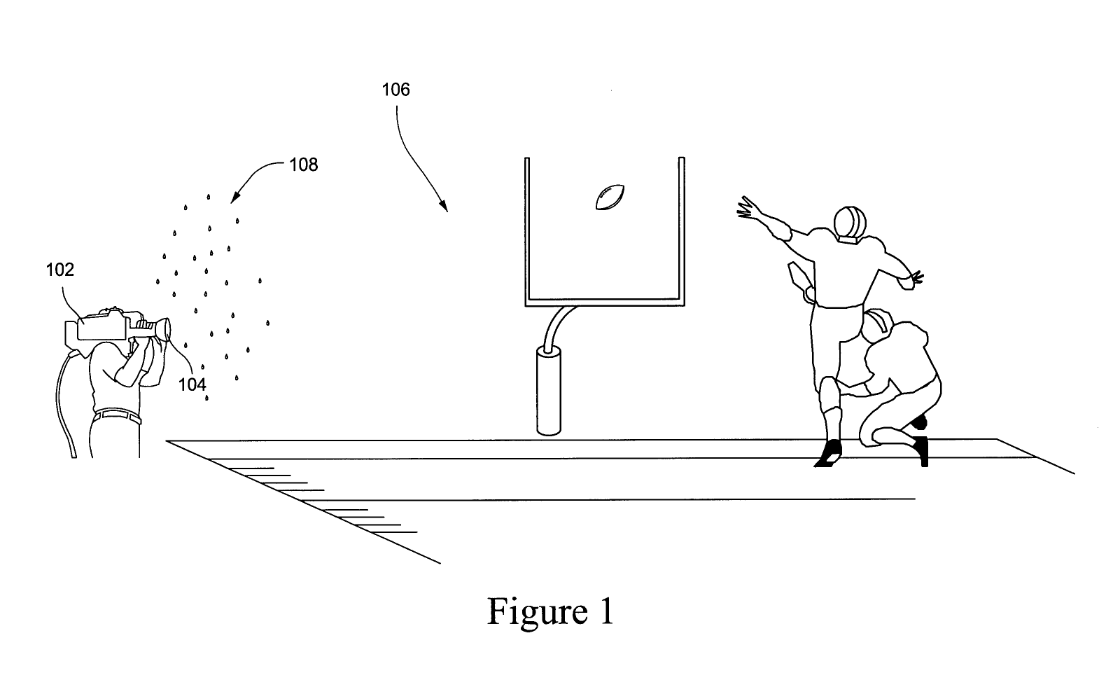

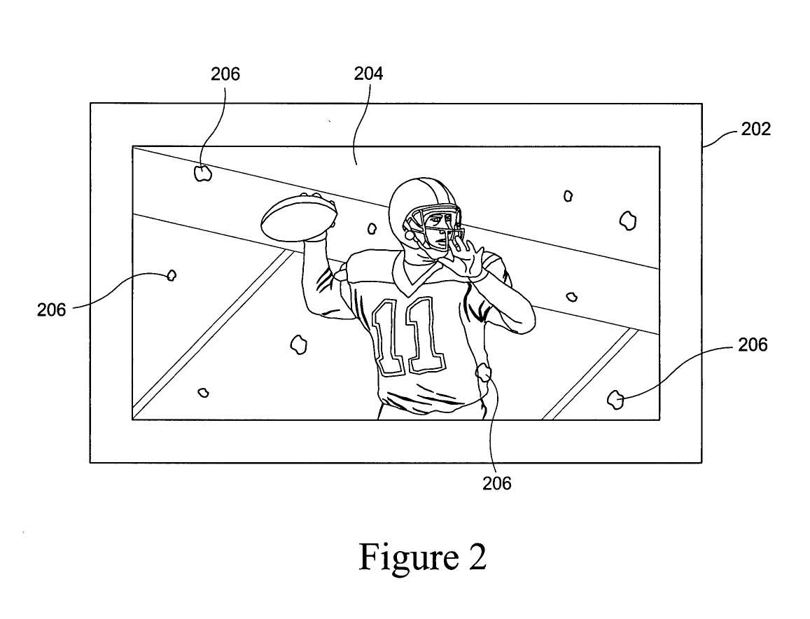

### DETAILED DESCRIPTION OF EXAMPLE EMBODIMENTS OF THE INVENTION

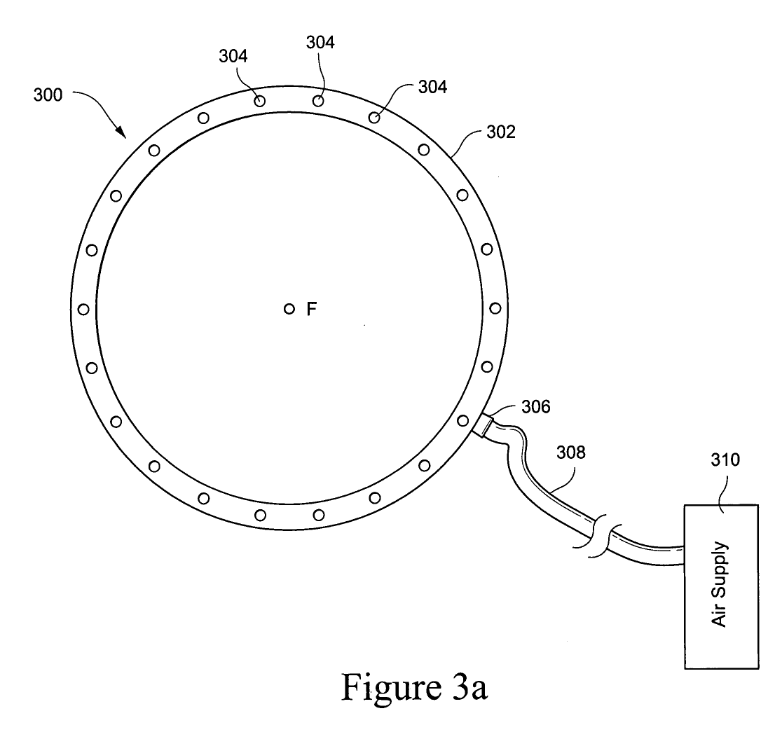

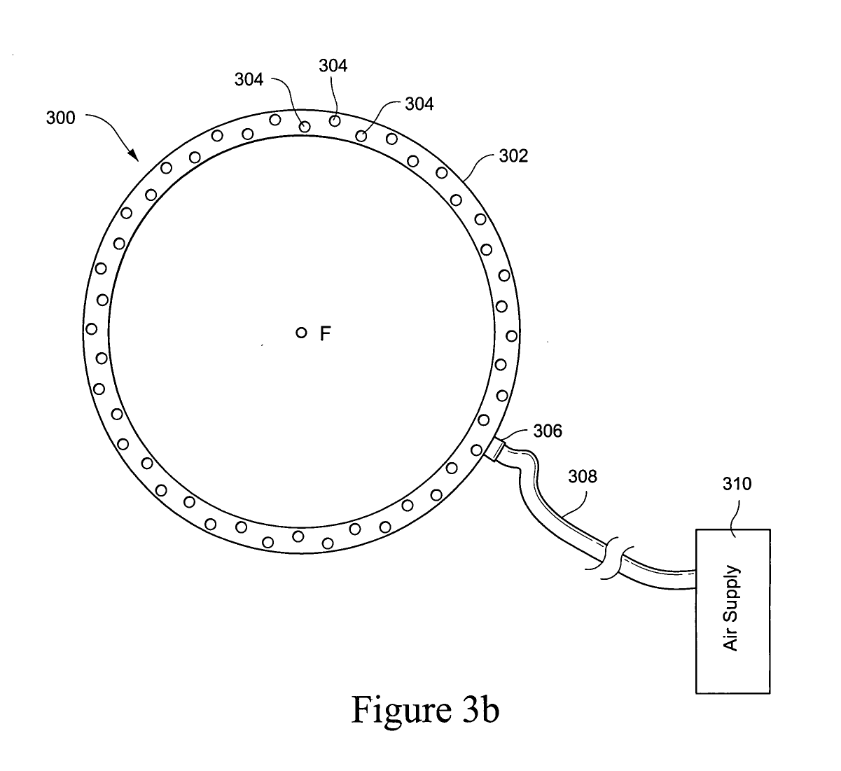

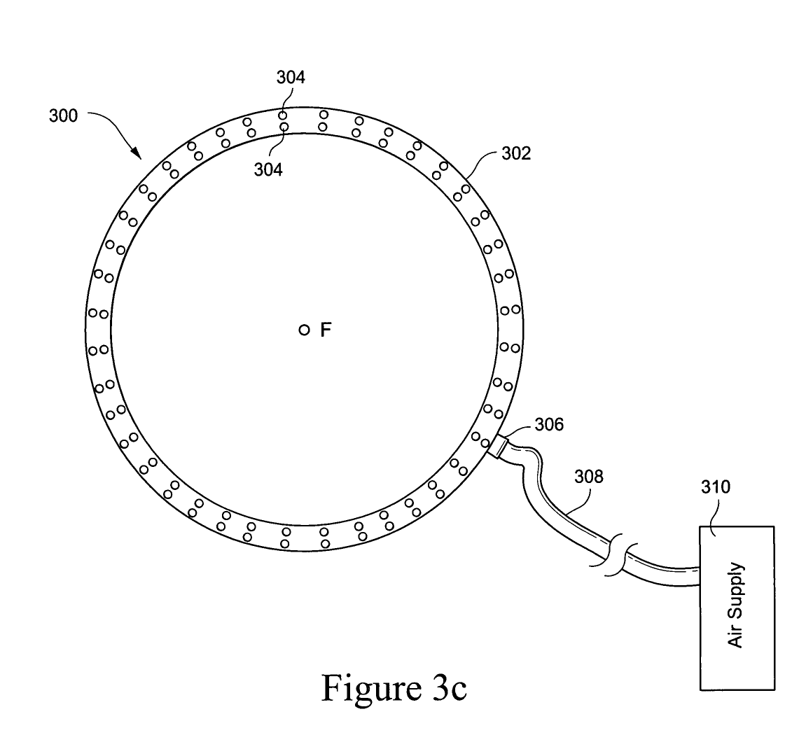

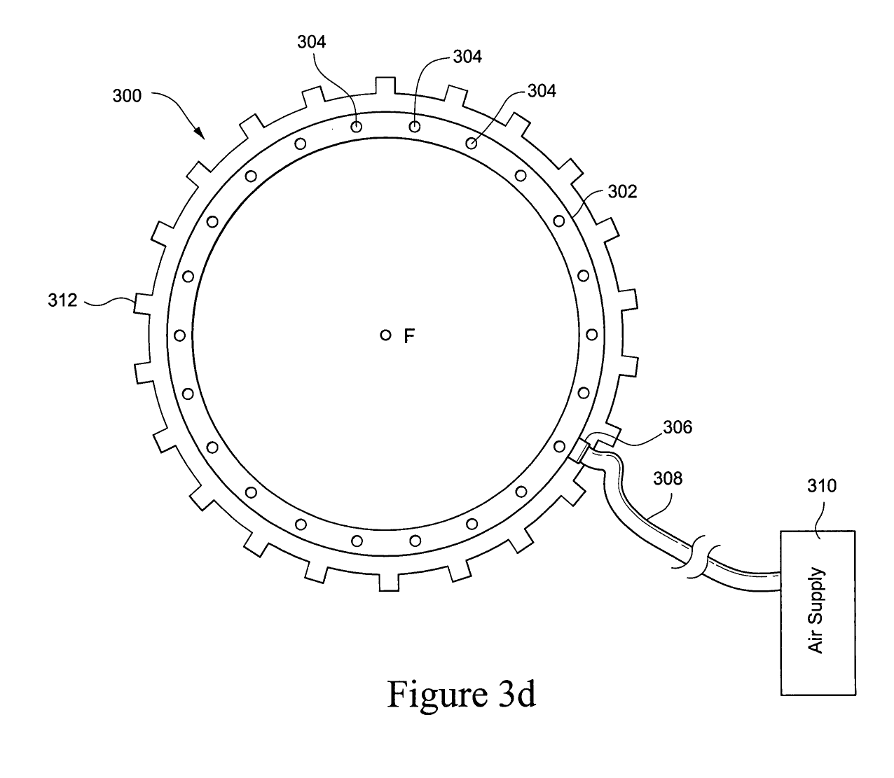

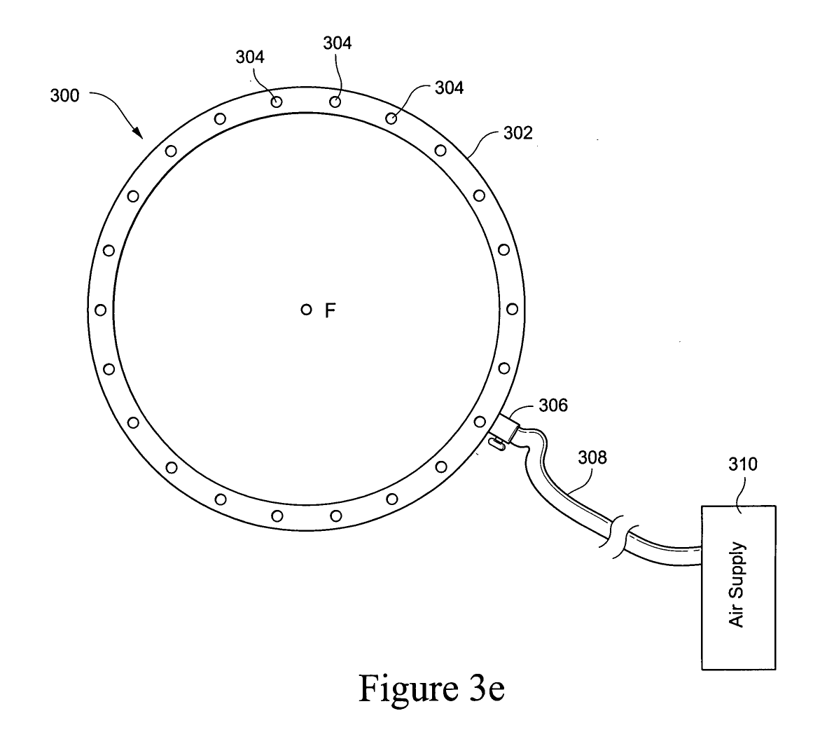

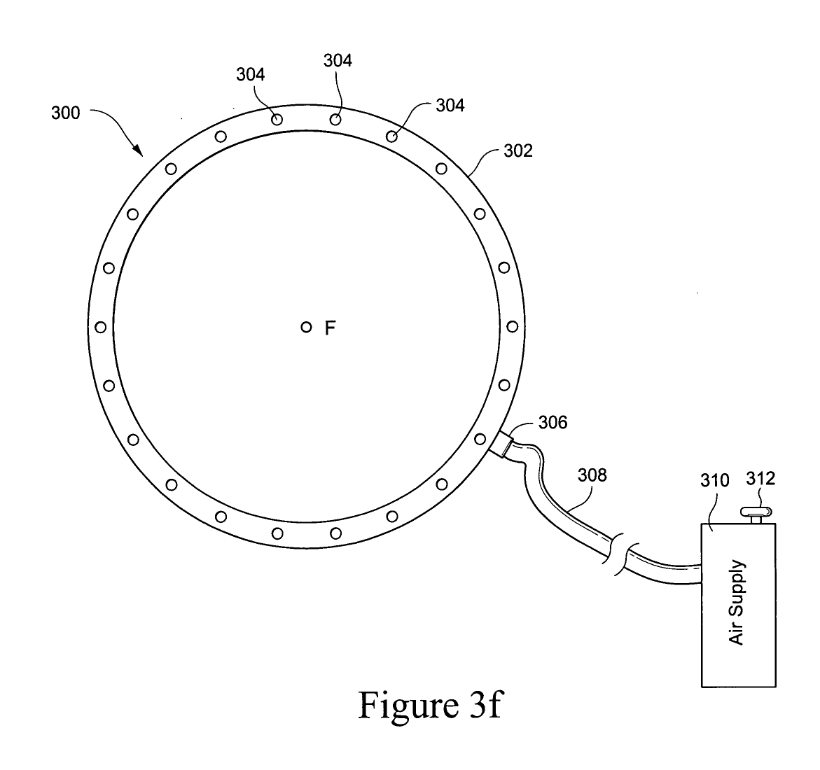

Referring now more particularly to the drawings, FIG. 3a is an example forced air environmental separator device 300, in accordance with an example embodiment. The separator device 300 may comprise a substantially circular collar 302 in a size suitable for being disposed around a lens of a camera. As lenses vary in size, the present invention itself is not limited to any particular size. Moreover, as lenses may be of different shapes (e.g., substantially rectangular, substantially ovular, substantially square-shaped, etc.), the collar 302 itself may be replaced with a correspondingly shaped structure suitable for the particular lens on the viewing device. Of course, it will be appreciated that a collar 302 of a different shape may be located around a smaller lens of a viewing device.

Disposed around the collar 302 are a series of holes 304. It will be appreciated that any number of holes 304 may be used, and that the locations thereof are not restricted to any particular configuration. For example, the holes 304 may be disposed completely or only partially around the collar 302. The holes 304 may be disposed at one or more angles. As described in greater detail below, this angling of the holes may allow air to be focused into one or more focal points, thereby establishing a buffer zone of air between the lens and debris or moisture. Furthermore, the air may angled inwardly in certain example embodiments to allow deposits to be removed and/or to cause the lens to be cleaned. Also, the holes 304 may be of a uniform diameter, although the present invention is not so limited. The holes 304 may be formed in the collar, bored or drilled into the collar, etc. In certain example embodiments, the holes 304 will not go all the way through the collar (e.g., and the collar 302 may be at least partially hollow to allow air to flow therethrough to the holes 304), whereas in certain other example embodiments, the holes 304 may be through-holes capable of receiving a supply of pressurized air directly.

FIG. 3b is another example forced air environmental separator device, in accordance with an example embodiment. As shown in FIG. 3b, the holes 304 are at least partially staggered and/or at least partially overlapping. This configuration may reduce the impact of further spaced apart holes while also having a reduced impact on the profile of the collar 302. Also, the at least partially staggered and/or at least partially overlapping configuration of the holes 302 also may reduce the chances of moisture and/or debris penetrating the buffer while also reducing the gaps (e.g., spaces) between the individual fluids comprising the air buffer.

Similar to the staggered arrangement shown in FIG. 3b, FIG. 3c is still another example forced air environmental separator device, in accordance with an example embodiment. As shown in FIG. 3c, the holes 304 are substantially in line with a diameter or a radius of the collar 302. That is, they are arranged substantially along a line that that passes through, or extends from, the center of the collar 302. In this and/or other ways, it may be possible to create multiple, substantially “concentric” cones of air. Additionally, or in the alternative, in this and/or other ways, it may be possible to effectively increase the “thickness” of the surface “walls” of a single cone of air. It will be appreciated that although two substantially in-line holes are shown in FIG. 3c, the present invention is not so limited. Instead, any number of substantially in-line spaced apart holes may be used in connection with certain example embodiments of this invention. For example, 2, 3, 4, or even more substantially in-line spaced apart holes may be used in connection with certain example embodiments. Also, it will be appreciated that the relative closeness of the substantially in line holes may be varied to achieve desired effects. For example, placing the substantially in-line spaced apart holes closer together may effectively increase the “thickness” of the surface “walls” of a single cone of air, whereas placing the substantially in-line spaced apart holes further apart may effectively create more discrete, substantially “concentric” cones of air.

A gasket or fitting 306 is provided to the collar 302 to allow a flexible conduit 308 (e.g., tube, piping, hose, etc.) to connect to an air supply 310. The air supply 310 may be a supply of compressed air itself and/or it may be an air compressor suitable to provide a supply of compressed air to the collar 302. Air from the air supply 310 may be forced through the flexible conduit 308 through the holes 304 in the collar 302 to form an air-based environmental separator.

It will be appreciated that a power supply may need to be provided in a case where an air compressor is provided. This power supply may be common to the viewing device (e.g., a common power source may power both a video camera and an air compressor), or it may be external to it (e.g., a telescope may have no power source at all in which case a separate power source may need to be provided for an air compressor, it may be disadvantageous to run a digital camera and an air compressor off of a common battery, etc.).

The rate at which air flows from the air supply 310 may be constant, or it may be variable. For example, the rate may be set in dependence on the amount of moisture and/or debris, and/or the force at which is it coming near to the lens. The flow may be triggered by a user action, or it may be automatically actuated. For example, it may be automatically actuated as soon as power is received, upon automatic detection of deposits forming on the lens, etc. In this respect, the flow also may be adjusted upwardly or downwardly automatically.

Furthermore, the rate at which the air flows and/or the air flow pressure may be adjusted using electronic and/or mechanical means. With respect to the former, in certain example embodiments, a user may manually increase the rate at which the air flows and/or the air flow pressure, e.g., using a keypad or other electronic device that instructs the air supply 310 to increase the rate at which the air flows and/or the air flow pressure. In certain example embodiments, a sensor may detect changes in the amount of ambient moisture, debris, etc., to be deflected, the amount of the same reaching the lens, etc., and correspondingly adjust the rate at which air flows and/or the air flow pressure. Thus, for example, when rain begins to come down harder or when rain begins to contact the lens, the rate at which air flows and/or the air flow pressure may be decreased. When rain begins to come down more softly, the rate at which air flows and/or the air flow pressure may be decreased. Similarly, the rate at which air flows and/or the air flow pressure may start low and ramp up until the environmental separator sufficiently reduces the amount of moisture contacting the lens or, conversely, may start high and ramp down until the minimum amount rate at which air flows and/or air flow pressure is reached. In this and/or other ways, it may be possible to more efficiently run the forced air environmental separator, e.g., by finding the minimum effective air flow rate and/or air flow pressure.

As alluded to above, mechanical means may be used to control the air flow rate and/or air flow pressure. FIGS. 3d-f show illustrative examples of such mechanical means. More particularly, FIG. 3d is an example forced air environmental separator device having an illustrative dial for adjusting air flow, in accordance with an example embodiment. In FIG. 3d, a knob or dial 312 may be located around the collar 302 of the forced air environmental separator 300. A user may manually adjust the dial 312 to correspondingly adjust the air flow rate and/or air flow pressure. For example, moving the dial 312 in a first direction may increase the air flow rate and/or air flow pressure, whereas moving the dial 312 in a second direction may decrease the air flow rate and/or air flow pressure. The movement of the dial 312 may accomplish the increase/decrease of the air flow rate and/or air flow pressure in response to the user's adjustments in any suitable way. For example, the dial 312 may adjust the apertures of some or all of the holes 304, individually or collectively.

FIG. 3e is another example forced air environmental separator device having an illustrative dial for adjusting air flow, in accordance with an example embodiment. In FIG. 3e, the dial 312 is provided on the gasket 306. It will be appreciated that adjusting the dial 312 when it is located on the gasket 306 will affect the air flow rate and/or air flow pressure of substantially all of the holes 304, as all of the air from the air supply 310 passes through this gasket 306 before reaching the holes 304.

FIG. 3f is still another example forced air environmental separator device having an illustrative dial for adjusting air flow, in accordance with an example embodiment. In the FIG. 3f embodiment, a dial 312 is provided directly on the air supply 312. Similar to the FIG. 3e embodiment, adjusting the dial 312 when it is located on the air supply 310 will affect the air flow rate and/or air flow pressure of substantially all of the holes 304, as this is the primary source of the air that passes through the holes 304.

The dials 312 in FIGS. 3d-3f may engage with grooves to cause predetermined levels of air flow rate and/or air flow pressure to flow through the holes 304. As such, it may be possible to provide typical settings, e.g., settings typical for torrential rains, heavy rain, light rain, fine mist, etc. It will be appreciated that any number of settings may be provided and that the labels for such settings may be varied or customized (e.g., may be based on a numerical scale, may be labeled according to a type and/or amount of debris, etc.). Alternatively, the adjustment of the dials 312 may be done in a more analog way. Although sometimes shown as having multiple teeth, any suitable dial 312 may be used in connection with certain example embodiments. It will be appreciated that multiple dials 312 may be provided in certain example embodiments, e.g., for adjusting the holes individually, in groups, or as one. For example, multiple dials 312 may be used when it is desirable to control, for example, the left, right, top, and bottom holes 304 independently of one another. As another example, multiple dials 312 may be provided for controlling the various holes 304 in the staggered hole arrangement of FIG. 3b and in the multiple in line hole arrangement of FIG. 3c.

Also, any suitable air supply may be used. Supplies of compressed air are commercially available, for example, from Roberts Oxygen. Air compressors are commercially available, for example, from Porter and Cable. Certain example embodiments may implement a 150 p.s.i. 6-gallon air compressor from Porter and Cable in connection with a ⅜″ ID air hose with ⅛″ diameter holes spaced ½″ apart. Of course, the present invention is not limited to this or any particular configuration. In general, the air flow and corresponding hole design, air hose diameter, and compressor requirements may be traded off to reflect different requirements. For example, a more highly powered air compressor may be needed for a longer and/or fatter air hose, whereas the hole design may be effective to channel the air at a higher pressure by virtue of a smaller diameter of the air holes compared to a larger diameter of the air hose.

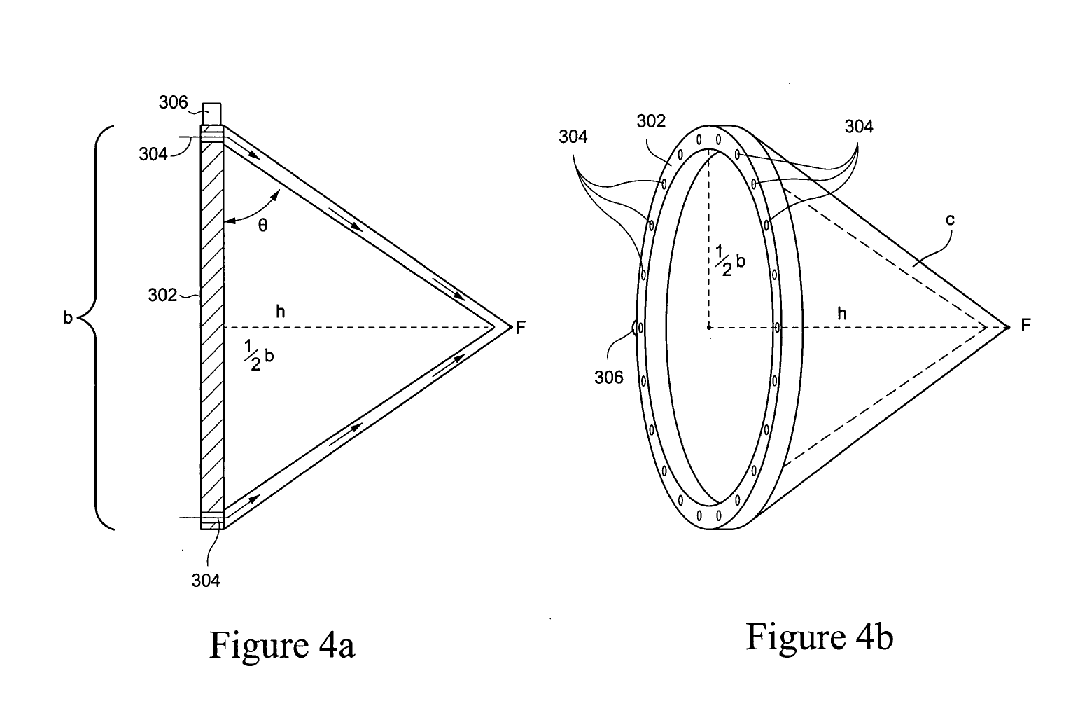

FIG. 4a is a simplified cross-sectional view of the example forced air environmental separator device 300 of FIG. 3a, in accordance with an example embodiment. For the sake of simplicity, the cross-section will be described as being a triangle, although it may be more appropriately thought of as a degenerate conic section (e.g., the rotation of which forms the cone described below with reference to FIG. 4b). Air from the air supply 310 is forced through the holes 304. The holes 304 are disposed at an angle so as to force the air from the face of the collar 302 at an angle θ, causing the air to be focused at point F. The length of the face of the collar 302 (e.g., the collar 302 diameter in the case where it is circular) is labeled b, and the distance from the center of the face of the collar 302 to the focal point F is labeled h. In this example, two right triangles are formed. The mathematical relationship may be modeled as sin θ=h/(½b). Thus, to focus the air into a single focal point F, the angle of the holes 304 should be θ=sin⁻¹ h/(½b).

As noted above, differently shaped collars 302 may require a plurality of angles to define a different air structure. One alternative shape for the collar 302 may be substantially rectangular, thus producing a substantially pyramidal shaped air buffer with a substantially rectangular base. In such a case, it is more convenient to think of the substantially pyramidal air structure in terms of the triangular faces comprising the substantially pyramidal air structure, which will be substantially isosceles in shape. Two different substantially isosceles triangles will be needed to comprise the faces, corresponding to the major and minor axes. For the triangles extending from the major axes, the base of the isosceles triangle will be the length of the major axis. For the triangles extending from the minor axes, the base of the isosceles triangle will be the length of the minor axis. The point at which all isosceles triangles will meet is the focal point F having a height h from the lens' surface. Based on these factors, it is possible to determine the angles at which the holes 304 for generating the isosceles triangles should be disposed. For the triangles extending from the major axes, the angle should be θ_{major axis}=sin⁻¹ h/(½ length_{minor axis}). Similarly, for the triangles extending from the minor axes, the angle should be θ_{minor axis}=sin⁻¹ h/(½ length_{major axis}). Of course, it will be appreciated that other shapes may be used for the base (e.g., a square shape, an oval shape, etc.), but the same or similar techniques as described above may be used to determine the angle(s) at which the holes 304 should be directed to form a focal point F at a given height h away from the surface of the lens and/or collar 302.

Also, the same or similar methods may be used if a configuration similar to an at least partially staggered and/or at least partially overlapping configuration (e.g., as shown in FIG. 3b) is implemented. In certain example embodiments implementing such configurations, multiple angles corresponding to the different positions of the holes with respect to the base may need to be used to account for the different base sizes. In certain other example embodiments, a common angle may be used for all holes, resulting in a “thicker” air buffer because in such embodiments the multiple flows of air will focus, on average, at point F.

The air may be focused at any distance from the lens, e.g., 1″, 2″, 3″, etc. The air need not be focused directly in the center of the lens. For example, in certain example embodiments, the air may be focused to a point to one side of the lens and, furthermore, the focal point may be out of the field of view of the imaging device. In such cases, it will be appreciated that the holes 304 will need to be angled differently depending on their location around the collar 304.

It will be appreciated that the amount of air forced through the holes 304 will depend at least in part on the size of the holes 304. This, in turn, may impact the quantity of debris and/or moisture that may be separated from the lens. Accordingly, the holes need not be uniformly sized, as it will be appreciated that in some situations (e.g., stationary filming) that little debris and/or moisture will float upwards, whereas this may not be the case in certain other situations (e.g., when a camera is recording footage from the back of an open jeep that kicks up dust, debris, gravel, etc.). In certain example embodiments, mechanical means may be used to adjust the aperture of the holes 304. For example, a simple swivelable dial may be used to adjust the apertures of the holes 304 to allow more or less air to flow therethrough. Alternatively or in addition, the holes may be redirected through mechanical means such as, for example, a swivelable dial, a prong for each hole allowing the hole to be redirected, etc.

FIG. 4b is a partial perspective view of the example forced air environmental separator device 300 of FIG. 3a, in accordance with an example embodiment. As before, the holes 304 around the collar 302 force the air into a focal point F. As is clearly shown in FIG. 4b, a cone C is formed, thereby reducing the amount of debris and/or moisture that may come into contact with the lens.

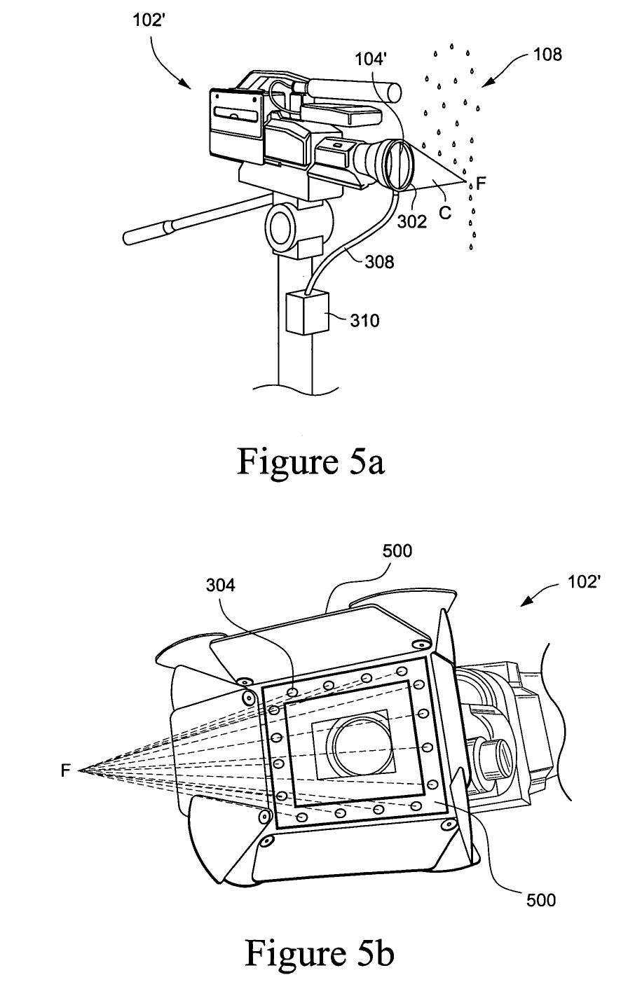

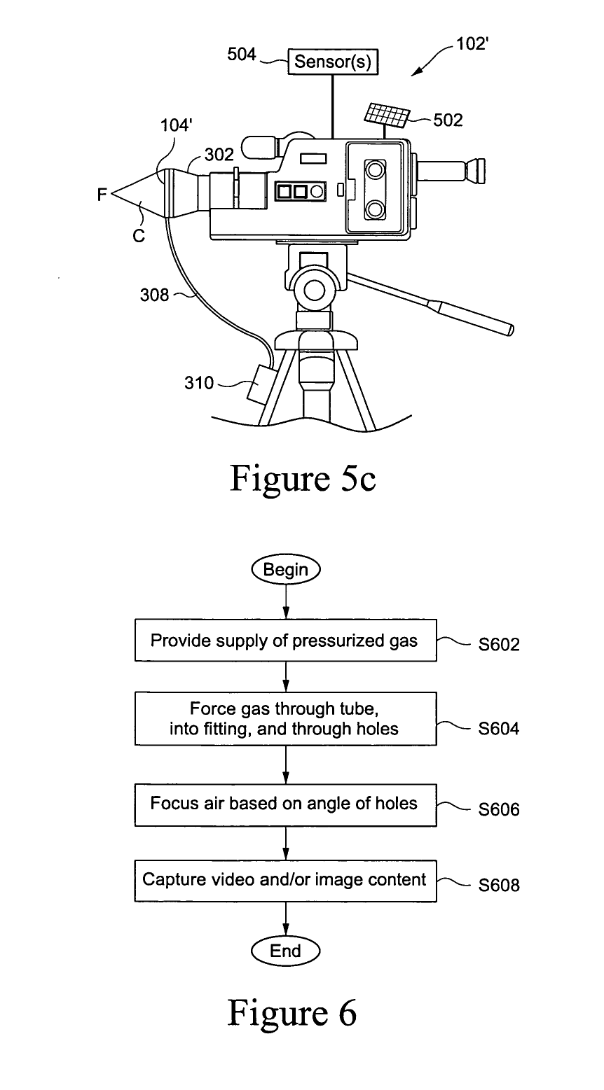

FIG. 5a is a video camera 102′ including a forced air environmental separator device 300 of FIG. 3a, in accordance with an example embodiment. Again, the air supply 310 provides air through the flexible conduit 308 to the collar 302. Here, a cone C is formed with its focus at point F. Any moisture and/or debris 108 will be forced outward from the lens 104′ towards the focal point F, where it will simply drop, potentially out of view of the camera, and advantageously with a reduced effect on the viewing, recording, and/or broadcasting experience.

In certain example embodiments, the collar 302 may be built into the video camera 102′ itself. In certain other example embodiments, the collar 302 may be connected to the outside of and/or around the lens 104′. In still other example embodiments, the collar 302 may be removably connected to the lens, e.g., via interlocking grooves or races existing on certain conventional video cameras (e.g., of the type that allow consumers to switch lenses, apply filters, etc.). In such a case, the collar 302 may be disposed between the camera and the lens, or on the lens after the lens attaches to the camera. It will be appreciated that although a video camera 102′ is shown in FIG. 5a, the present invention is not limited to this or any particular type of imaging device. For example, certain example embodiments may be used in connection with still cameras, digital cameras, binoculars, telescopes, scopes, glasses or goggles, etc., or any type of viewing device. Thus, in certain example embodiments, the collar may be at least as big as the lens it is to protect, whereas the collar may be more closely fitted to the size of the lens in certain other examples.

FIG. 5b is another video camera including a forced air environmental separator device located in the frame or hood of its matte box, in accordance with an example embodiment. Matte boxes are known ways of extending a user's ability to modify and control light prior to it entering the camera's lens. For example, a matte box may be used to flag and block errant light from directly striking a lens, which may sometimes cause unwanted lens flares. Additionally, top French flags and/or side flags also help keep light away from the lens. Glass filters may be added using a matte box, e.g., to apply neutral density correctors, polarizers, and/or color enhancers. In general, such filters slip into trays, which may be inserted into the filter stages of the matte box. Matte boxes may be made of metal, plastic, etc. A 4×4 size matte box may be used in connection with traditional 4×3 aspect ratio cameras, and a 4×5.6 size matte box may be used in connection with 16×9 aspect ratio cameras.

As shown in FIG. 5b, the forced air environmental separator is built into the frame or hood of the matte box 500. In the FIG. 5b example embodiment, the forced air environmental separator is located in front of, or exterior to, the trays and/or filter stages of the matte box. In certain other example embodiments, the forced air environmental separator may be located at, closer to, or farther from the outermost periphery of the matte box. For example, in certain example embodiments, the forced air environmental separator may be located around the outside of top French and/or side flags, whereas the forced air environmental separator of certain other example embodiments may be located closer to the actual lens of the camera. Thus, it will be appreciated that the forced air environmental separator of certain example embodiments may be located anywhere within the frame or hood of a matte box. It also will be appreciated that the forced air environmental separator of certain example embodiments may be integral with matte box and/or the camera, or it may be provided as a separate component thereto.

FIG. 5c is still another video camera including a forced air environmental separator device, in accordance with an example embodiment. The example embodiment shown in FIG. 5c is similar to FIG. 5a. However, the camera 102′ of FIG. 5c also has a solar panel 502 connected thereto to provide it with power. Also, one or more sensors 504 are provided to the camera 102′. The one or more sensors 504 may detect the presence of rain or debris, wind conditions, temperature conditions, etc. Any known rain, moisture, debris, light, pressure, barometer, hygrometer, temperature, wind, and/or other sensors may be used in connection with certain example embodiments. For example, rain and/or moisture sensors are known in the automotive industry and may be adapted for use with certain example embodiments. For example, automotive moisture and debris sensors are disclosed in U.S. Publication Nos. 2007/0200718, 2007/0162201, 2007/0157722, 2007/0157721, and 2007/0157720, the entire contents of each of which is hereby incorporated herein by reference.

Based on information collected by the one or more sensors 504, the air flow rate and/or air flow pressure may be adjusted. Because the camera 104′ of FIG. 5c may be self-powering and/or self-adjusting in response to ambient conditions detected by the one or more sensors 504, it may be used in connection with surveillance, military, homeland security, and/or other applications. In such cases, the camera 104′ of FIG. 5c may be located at a fixed location, such as, for example, ports, airports, military installations, border crossings, etc. The camera 104′ may rotate, store, and/or forward captured images and/or video, as is known in the surveillance arts.

FIG. 6 is an illustrative flowchart showing a method for reducing the number of deposits that may form on a lens of a viewing device. In step S602, a supply of pressurized gas is provided. The pressurized gas may come from a supply of pressurized air, or an air compressor may compress gas during operation. The gas may be forced through a tube into a fitting and through a plurality of holes disposed around a collar located around a lens in step S604. In step S606, Based at least in part on the angle(s) of the holes, the air may be focused into one or more focal points at one or more predetermined locations relative to the lens and/or collar. Depending at least in part on the geometry of the lens, collar, and/or configuration of the holes, an air-based environmental separator will be formed as, for example, a cone, a pyramid, etc. It will be appreciated that these focal points may be located directly in the center of the lens, to the side, etc. The chances of deposits forming on the lens therefore may be reduced, allowing video and/or image content to be captured clearly and/or cleanly in step S608.

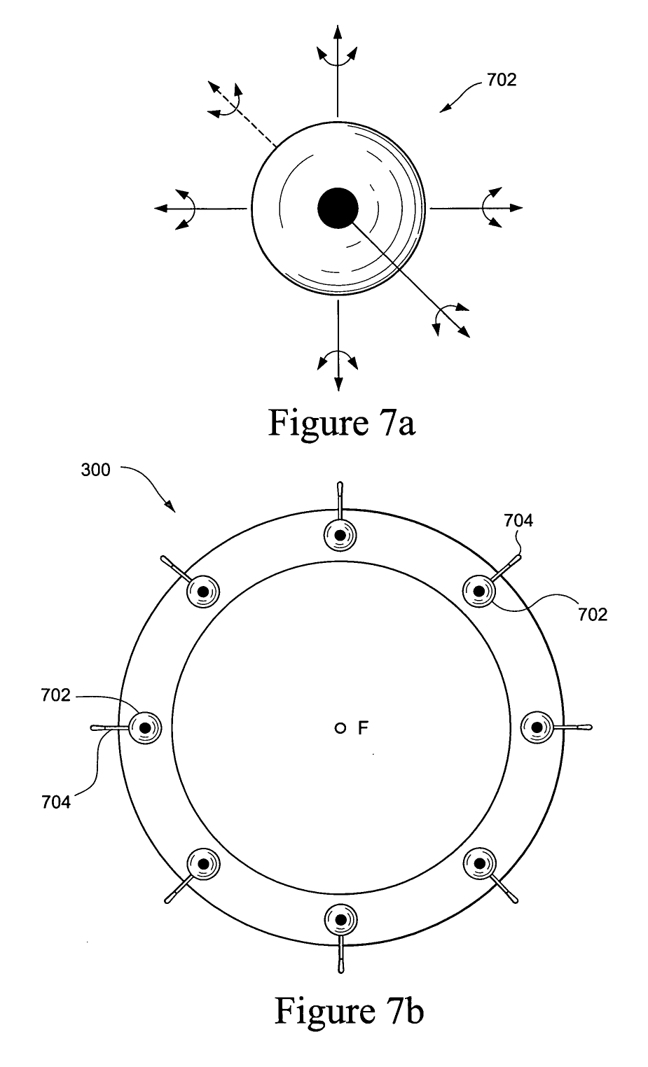

As an alternative, or in addition, to providing mere holes through which air may pass, movable air jets may be provided in connection with certain example embodiments. The jets may be movable in a number of ways. For example, FIG. 7a is an illustrative air jet that may be moved in six degrees of freedom, in accordance with an example embodiment. That is, the air jet 702 of FIG. 7a may be moved translationally along and/or rotationally about the X, Y, and/or Z axes. As shown in FIG. 7a, the air jet 702 is substantially spherical so as to be movable within, for example, a ball-and-socket joint. In this way, the air jet 702 is somewhat similar to air jets provided in airplanes. However, the air jet may be differently shaped in certain other example embodiments of this invention. For example, in certain example embodiments, the jet may be more cylindrically shaped, or similar to the jets found in hot tubs.

FIG. 7b is an illustrative forced air environmental separator device including a plurality of the illustrative air jets shown in FIG. 7a, in accordance with an example embodiment. More particularly, a plurality of air jets 702 are arranged around the forced air environmental separator 302 in place of the holes, e.g., of the FIG. 3a embodiment. Stems or other movement means 704 are provided to each of the jets 702, allowing each respective jet 702 to move translationally and/or rotationally. In certain example embodiments, the jets 702 may be moved independently, in groups, and/or as a whole.

In these and/or other ways, the respective paths of air flows from the jets 702 may be positioned or finely tuned so as to improve the deflection capabilities thereof. For example, the air jets 702 may be positioned and/or moved so that the air flows emanating therefrom constructively or destructively interfere with each other. For example, the air jets 702 may be positioned and/or moved such that the individual air flows generally meet up at a focal point. The positioning and/or movement of the jets additionally may be such that a desirable cyclonic or swirling effect is produced, thereby potentially improving the deflecting and/or shielding capacity of the forced air environmental separator. The air flows from the jets 702 may be made to spin independently, in groups, and/or as a whole.

The cyclonic and/or swirling effects generated by the jets also may be generated using holes. For example, the angling, positioning, and/or bores of the holes relative to each other may be such that the desirable cyclonic or swirling effect is produced, thereby potentially improving the deflecting and/or shielding capacity of the forced air environmental separator.

In certain example embodiments, the holes may be bored and/or jets the jets constructed such that the air travels through a torturous path. Such arrangements advantageously may create the desired cyclonic and/or swirling effects described above. Additionally, such arrangements also may help increase the discharged pressure close to the lens, thereby potentially improving the deflecting and/or shielding capacity of the forced air environmental separator. In these and/or other arrangements, the holes and/or jets may have a fixed and/or variable relationship to each other so that one or more desirable effects of the air may be achieved.

One approach to keeping lenses clean involves spray deflectors. In brief, a spray deflector is a substantially transparent layer disposed over a camera lens. The spray deflector rotates, typically about the center of the lens, or actually is a rotating lens in and of itself. When water or debris contacts the rotating spray deflector, the frictional contact causes a centrifugal force that forces the water or debris outwards, thereby keeping the substantially transparent layer and/or the lens clean. Unfortunately, spray deflectors suffer from several disadvantages. For example, water droplets and/or debris may fragment into one or more pieces, and the movement thereof is sometimes detectable across the several frames of a video or on a still picture. Additionally, water droplets and/or debris has been found to congregate at the center of the spray deflector. Because the centrifugal force is insubstantial near the center of the spray deflector, the center sometimes is not cleaned. This leaves a discernable artifact that is detectable across the several frames of a video or on a still picture. Additionally, the mass at the center of the spray deflector may increase, e.g., as water droplets and/or pieces of debris agglomerate. Thus, the artifact grows and grows.

Although conventional spray deflectors generally are disadvantageous, certain example embodiments may incorporate and modify spray deflector designs. For example, spray deflectors may be used in connection with the jets to further reduce any moisture or debris that is able to pass through the air barrier and reach the lens. In such example cases, the spray deflector may force the moisture or debris outwardly towards the air flows. The air flows may then force the moisture or debris outwardly and away from the lens. Additionally, or in the alternative, one or more air jets or holes may be pointed at the lens (e.g., towards the center of the lens) to help reduce the chances of moisture and/or debris from forming at the center of the lens. In certain example embodiments, one or more air jets or holes may be pointed at the lens to help reduce the chances of moisture and/or debris from forming at the center of the lens, regardless of whether a spray deflector is used. Thus, certain example embodiments are capable of improving upon the techniques of conventional spray deflectors by incorporating one or more other example techniques described herein.

It will be appreciated that the forced air environmental separation techniques of certain example embodiments may be used in any number of fields. Applications may include, for example, sporting events, amateur or professional still photography, wildlife photography, hunting, surveillance, traffic cameras (e.g., red light cameras, speeding cameras, etc.), astronomy, weather watching, special effects, stunt photography, concerts, movie and/or television products, skiing, motor cross, emergency response, etc.

### Example

It will be appreciated that the example embodiments described herein may be considered substantially the same with any subset of the following modifications, any or all of which could be implemented as dynamic features on a single design and which could allow adjustment of the design during use:

1. Asymmetric configuration of the holes in the camera casing
2. Non-uniform, adjustable hole size
3. Capability to change the flow volume or velocity to adjust for conditions
4. Capability to use only a fraction of the available holes at any given time
5. Capability to adjust the angles of the holes, moving the focus of the air jets closer to or further from the center of the lens
6. Capability to create multiple barriers via adjustment of the hole angles and placement

This example is applicable to any particle(s) flying through the air, such as rain, fog, dirt, mud, rocks, cut grass, leaves, etc. The example is applicable in substantially the same way for any application in which a camera is being used in circumstances that might require protection of the lens. This is not limited to water droplets on the lens, and instead includes, for example, scratching or denting of the lens by small rocks, the accumulation of debris on the lens, and/or any other such occurrence that generally would adversely affect the use of the camera. The size and shape of the lens(es) also do not limit the applicability of this example.

The sample calculations below demonstrate the feasibility of the design without restricting it to any of the assumptions. It will be appreciated that an effective implementation of this design may seek to maximize the effective force of the air and to create a substantially uniform shield over the lens. The turbulent flow of the air through the tubing leading to the casing and through the holes will decrease the effective flow velocity, as will the turbulent mixing with the ambient air. A large source of compressed air or an air compressor may be required to operate a product designed based on this example for an extended period. The pressure required upstream to achieve the necessary flow parameters is achievable, though not insignificant, and this design is substantially the same regardless of the compressed air source or flow configuration upstream of the casing. It will be appreciated that the force required, and therefore the upstream pressure required, will increase as the size of the lens increases.

The air velocity and mass flow will decrease as the air moves away from the casing due to the mixing of the jet with the ambient air, reducing the force available to act on any impinging particle. However, the force required decreases as well because the necessary deflection is smaller. A particle striking the air barrier nearer the focus than the lens is both lower vertically and further away horizontally than a particle striking near the lens. A slight downward deflection would typically suffice for the particle nearer the focus, instead of a complete elimination of the horizontal velocity in the direction of the lens.

It is left to the specific implementation to determine the required flow parameters for any desired range of conditions for successful operation. In addition, the angle and force of the air shield must be chosen to provide sufficient horizontal force near the lens, but also to close the cone/pyramid quickly enough to have sufficient force to deflect a particle impinging at the maximum angle for a certain set of conditions. For example, someone stepping in a puddle could generate a drop traveling horizontally near the lens. The barrier must have sufficient force along the lens centerline at the apex or focus to deflect such a particle. These requirements could be determined analytically, or by trial and error. It will be appreciated that it would be advantageous in certain example embodiments to use the minimum air flow required to achieve lens protection is ideal, thereby also reducing compressed air usage.

No significant force is required to keep a particle off a camera lens if the lens is flush with the casing and the particle is falling exactly vertically. However, rain is frequently accompanied by a non-trivial wind, which results in the rain falling at a noticeable angle to the ground. For the purposes of a sample calculation, an angle of 30 degrees will be assumed. This horizontal velocity is a result of the translation of the medium and must be added (e.g., as a separate component) to the vertical velocity to obtain the total velocity of the drop. It will be apparent that similar calculations may be performed for any angle such that the particle would strike the lens if not diverted. The range of possible angles forms a hemisphere, based on the plane of the lens.

The horizontal velocity of the particle is one component that may be addressed by the blown-air system described herein. The sample calculation below considers the worst-case scenario in which the camera is held directly into the wind, such that the wind is striking the camera face perpendicularly. It will be appreciate that if the camera were otherwise oriented, the force required to maintain a clean lens would be less than that calculated here.

For the following calculation, a number of assumptions are made to eliminate the need for complex, physics-based models. However, the assumptions are within reason for the actual use of the invention, and the calculation represents an approximation of a realizable configuration and operating condition for this example.

It has been determined that a rain drop of diameter 5.8 mm falls with a velocity of about 9.17 m/s. The density of water at standard day temperature is known to be about 1 g/cc. Assuming the drop to be spherical, the volume is given by (4/3)* [symbol] *r³, and the mass can be found by multiplying the volume and the density. Raindrops are estimated to vary in mass from about 0.004 g in a drizzle to about 0.3 g in a downpour. The about 5.8 mm drop has a mass of about 0.1 g, which will be used as the sample drop size for this calculation.

For a large raindrop falling at 9.17 m/s vertically, adding a horizontal component of 4.59 m/s creates a 30 degree angle with the vertical and a total velocity of 10.25 m/s. Assume that this particle is on a path to impact the lens at its top edge, leaving the minimum possible horizontal distance for the air to deflect the drop away from the lens. Assume that the holes and air flow are configured around a circular lens in such a way that the air barrier is 1 cm thick at all points, meaning a particle falling through the air flow perpendicularly to the flow velocity would be in the primary air stream for 1 cm. Assume that this flow is uniform for the area under consideration. For convenience, assume that the holes are configured to create the barrier at 30 degrees relative to the centerline axis of the lens. This results in the air flowing perpendicularly to the rain.

Assume the raindrop has a diameter of 5.8 mm, and assuming a spherical shape and density of 1 g/cc, a mass of 0.1 g. Momentum is the product of mass and velocity, and the raindrop would have a horizontal momentum of 0.46 g*m/s.

Assume that the air barrier has a flow velocity of 120 m/s, and that the density is consistent with air density under standard conditions (1.3 kg/m³). Any density increase from the compression would be beneficial, but the upstream compression would not necessarily lead to an increase in density in the barrier. Consider the mass flow through a rectangular window defined by the height of the barrier (1 cm) and the width of the particle (0.58 cm). Multiplying the density by the area and the flow velocity gives 9.0 g/s. With the raindrop falling at 10.25 m/s and assuming a consistent velocity through the air flow, the raindrop will take approximately 1 ms to fall through the barrier. Because the drop diameter is approximately half the height of the barrier, assume that only half of the total mass flow strikes the drop at any given time throughout the 1 ms. The result is that a mass of 0.0045 g strikes the particle as it passes through the barrier. Multiplying by the velocity, the momentum impinging on the particle is 0.54 g*m/s.

Assume that the air transfers its momentum completely to the particle, that the particle can be treated as a point mass for the purposes of momentum transfer, and that the momentum transfer happens instantaneously. Using the conservation of momentum, the raindrop will then have a new velocity component of 5.4 m/s in the direction of the air flow. Multiplying by cos(30) to account for the assumed angle of the airflow relative to the horizontal, the horizontal velocity component is 4.7 m/s. Thus, the raindrop falls almost vertically at about 11.9 m/s, leaving the lens untouched.

This simplified calculation demonstrates that the invention, substantially as described herein, is feasible. It will be appreciated that at least some of the assumptions made in this calculation were not optimal for performance of the system. For example, the raindrop used was fairly large, and the assumed location was the worst possible. In addition, the camera is being held directly into the wind. Thus, the example system as described would clearly be effective against smaller drops at lesser angles.

On the other hand, it will be appreciated that some assumptions were beneficial, but not unreasonable. The flow velocity of 120 m/s is nontrivial, but a typical paintball gun powered by compressed air or CO₂ propels a pellet much larger than a raindrop at 90 m/s. The likely deformation of the raindrop under the complex forces of a real airflow is well beyond the scope of this discussion, but is expected to reduce the air's effect only slightly. A constant airflow would establish slower flow outside the core centimeter assumed here, contributing to the total force on the drop. It is also assumed that the wind does not affect the air velocity around the lens. In windy conditions, the wind could either help or hurt example embodiments of this invention. For instance, it will be appreciated that if the wind is directed at the camera's face as in this example, a higher velocity would be required to achieve protection, especially further from the lens.

Other changes could be made to improve performance as well. For example, using carbon dioxide instead of air would increase the density by about 50%, providing more force for the same flow velocity. The thickness of the barrier cone could be increased, increasing the time that the particle is exposed to the flow. By using multiple rings of holes, a second conical barrier could be created inside the original. The flow parameters could be configured such that the outer barrier protects against drops near the top of the lens, and the inner barrier with a larger cone angle relative to the lens centerline protects against particles moving more horizontally.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A viewing device comprising an element deflector configured to reduce a number and/or amount of deposits from forming on a lens of the viewing device, the element deflector comprising:
an air supply configured to supply a flow of pressurized air;
a matte box including a plurality of holes formed in a frame or hood thereof, the plurality of holes being disposed at one or more angles such that the flow of pressurized air is capable of flowing through the holes to reduce the number and/or amount of deposits from forming on the lens of the viewing device; and
a conduit connecting the air supply to the holes of the matte box so that the flow of pressurized air flows from the air supply through the conduit to the holes of the matte box.

2. The viewing device of claim 1, wherein the holes are disposed at the plurality of angles so as to cause the flow of pressurized air to converge at least one focal point.

3. The viewing device of claim 1, wherein the holes are bored and/or positioned so as to generate a cyclonic or swirling flow of air.

4. The viewing device of claim 1, wherein the holes are arranged substantially in line with a line starting at the lens' center.

5. The viewing device of claim 2, wherein the at least one focal point is located in front of the lens at a point along a line extending perpendicular to the lens from the lens' center.

6. The viewing device of claim 2, wherein the holes are disposed at the plurality of angles so as to cause the flow of pressurized air to form a cone and/or pyramid of air, with the frame or hood of the matte box forming a base of the cone and/or pyramid.

7. The viewing device of claim 1, wherein the holes are arranged in a substantially oval or rectangle shape in the frame or hood of the matte box.

8. The viewing device of claim 1, wherein the air supply is a supply of compressed air.

9. The viewing device of claim 1, wherein the air supply includes an air compressor to compress air.

10. The viewing device of claim 1, wherein at least some of the holes are angled or angleable towards the lens.

11. The viewing device of claim 1, further comprising a spray deflector configured to generate a centrifugal force in response to frictional contact associated with deposits coming into contact with the spray deflector sufficient to move the deposits off of the lens of the viewing device.

12. The viewing device of claim 1, wherein the viewing device is one or more of a video camera, still camera, telescope, binoculars, glasses or goggles, and/or scope.

13. A viewing device comprising an element deflector configured to reduce a number and/or amount of deposits from forming on a lens of the viewing device, the element deflector comprising:
an air supply configured to supply a flow of pressurized air;
a plurality of rotatable and/or translatable jets formed around the lens of the viewing device, the plurality of jets being positionable at one or more angles such that the flow of pressurized air is capable of flowing therethrough to reduce the number and/or amount of deposits from forming on the lens of the viewing device; and
a conduit connecting the air supply to the jets so that the flow of pressurized air flows from the air supply through the conduit to the jets.

14. The viewing device of claim 13, wherein the jets are positionable at the plurality of angles so as to cause the flow of pressurized air to converge at least one focal point.

15. The viewing device of claim 14, wherein the at least one focal point is located in front of the lens at a point along a line extending perpendicular to the lens from the lens' center.

16. The viewing device of claim 14, wherein the jets are positionable at the plurality of angles so as to cause the flow of pressurized air to form a cone and/or pyramid of air, with the lens forming at least a part of a base of the cone and/or pyramid.

17. The viewing device of claim 13, wherein the jets are arranged in a substantially oval shape around the lens.

18. The viewing device of claim 13, wherein the holes are arranged in a substantially rectangle shape around the lens.

19. The viewing device of claim 13, wherein the jets are formed and/or positioned so as to generate a cyclonic or swirling flow of air.

20. A method of reducing the number of deposits that form on a lens of a viewing device, the method comprising:
providing a supply of pressurized gas from an air source;
forcing the supply of pressurized gas from the air source through a tube through a plurality of holes or jets disposed in a frame or hood of a matte box of the viewing device; and
focusing the supply of pressurized gas into at least one focal point at one or more predetermined locations relative to the lens.
